(19) United States
(12) Patent Application Publication
(10) Pub. No.: US 2023/0103865 A1
(43) Pub. Date: Apr. 6, 2023

(54) ELECTRONIC COMPONENT AND COIL COMPONENT

(71) Applicant: Murata Manufacturing Co., Ltd., Kyoto-fu (JP)

(72) Inventors: Yoshifumi MAKI, Nagaokakyo-shi (JP); Atsuo HIRUKAWA, Nagaokakyo-shi (JP)

(73) Assignee: Murata Manufacturing Co., Ltd., Kyoto-fu (JP)

(21) Appl. No.: 17/936,318

(22) Filed: Sep. 28, 2022

(30) Foreign Application Priority Data
Oct. 4, 2021 (JP) 2021-163409

(51) Int. Cl. H01F 27/29; H01F 27/28; H01F 27/32

(52) U.S. Cl. CPC H01F 27/292; H01F 27/2804; H01F 27/323; H01F 2027/2809

(57) ABSTRACT

An electronic component includes a body having a mounting surface which faces a mounting substrate and an exposure surface from which an extended wiring line is exposed, a first electrode attached to the mounting surface, and a second electrode which is electrically connected to the extended wiring line and which is attached to the exposure surface. The first electrode and the second electrode second electrode are spaced from each other.

### CROSS-REFERENCE TO RELATED APPLICATION

This application claims benefit of priority to Japanese Patent Application No. 2021-163409 filed Oct. 4, 2021, the entire content of which is incorporated herein by reference.

### BACKGROUND

### Technical Field

The present disclosure relates to an electronic component and a coil component.

### Background Art

Japanese Unexamined Patent Application Publication No. 2018-137285 and Japanese Unexamined Patent Application Publication No. 2019-79844 disclose an electronic component (a capacitor or an inductor) including a body and an outer electrode extending from a principal surface of the body to a side surface of the body. The outer electrode includes an electrode layer and a plating layer. According to the electronic component, the outer electrode can be electrically connected to a circuit board by using solder.

### SUMMARY

When an outer electrode is electrically connected to a circuit board by using solder as described in Japanese Unexamined Patent Application Publication No. 2018-137285 and Japanese Unexamined Patent Application Publication No. 2019-79844, the shrinkage of the solder occurs due to the cooling of the solder. Therefore, the tensile stress due to the shrinkage of the solder is applied to the outer electrode. This results in the outer electrode peeling from a body, potentially decreasing the reliability of an electronic component.

Accordingly, the present disclosure provides a highly reliable electronic component and coil component.

An electronic component of the present disclosure includes a body having a mounting surface and an exposure surface from which an extended wiring line is exposed, a first electrode attached to the mounting surface, and a second electrode which is electrically connected to the extended wiring line and which is attached to the exposure surface. The first electrode and the second electrode are spaced.

A coil component of the present disclosure is such that, in the above-mentioned electronic component, the body is formed by laminating coil conductor layers, via conductors and insulation layers.

According to the present disclosure, a highly reliable electronic component and coil component can be provided. Specifically, a first electrode and a second electrode are spaced, thereby enabling a reduction in the tensile stress due to the shrinkage of solder.

### BRIEF DESCRIPTION OF THE DRAWINGS

FIG. 1 is a perspective view of an electronic component of the present disclosure;

FIG. 2 is a sectional view of a coil component that is an aspect of the electronic component of the present disclosure;

FIG. 3 is a plan view of each lamination member that forms a body in the coil component that is the aspect of the electronic component of the present disclosure;

FIG. 4 is an enlarged sectional view of a dotted-line portion of FIG. 2; and

FIG. 5 is an enlarged sectional view of an electronic component of a comparative example.

### DETAILED DESCRIPTION

An electronic component of the present disclosure is described below in detail. Although description is made with reference to drawings as necessary, illustrated contents are only schematically and exemplarily shown for the purpose of understanding the present disclosure and appearances, dimensional ratios, and the like may be different from actual ones.

Electronic Component of Present Disclosure

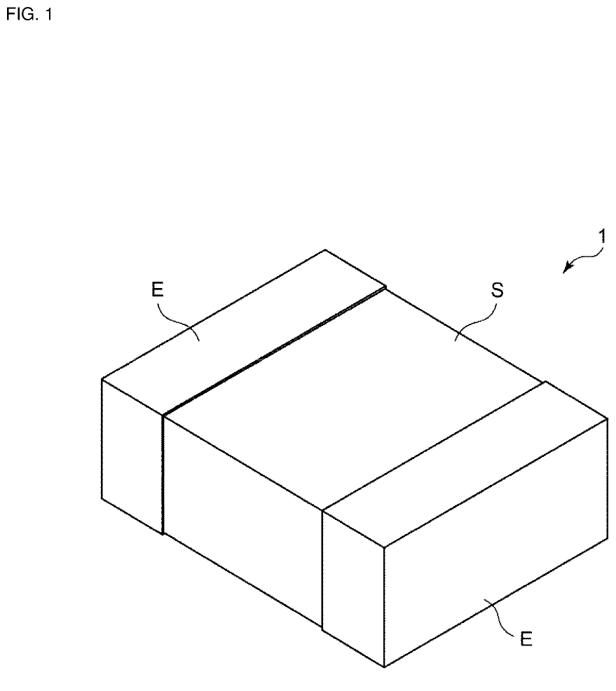

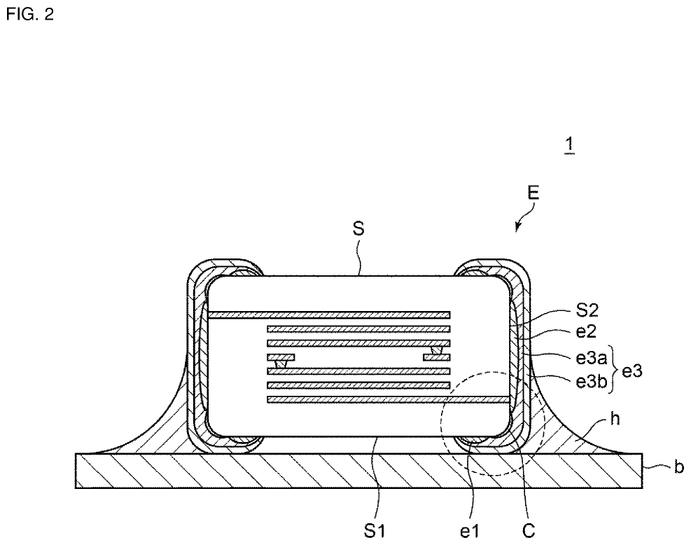

The electronic component of the present disclosure is provided with a body S and outer electrodes E (refer to FIG. 1). The body S has a mounting surface S1 that faces a mounting substrate b and an exposure surface S2 from which an extended wiring line is exposed. The outer electrodes E include a first electrode e1 attached to the mounting surface S1 and a second electrode e2 attached to the exposure surface S2 (refer to FIG. 2 as an example). The first electrode e1 and the second electrode e2 are spaced from each other. The term “spaced” as used herein refers to a state in which the first electrode e1 and the second electrode e2 are not in contact but are separated.

The electronic component in which the first electrode e1 and the second electrode e2 are spaced from each other as described above enables a reduction in the tensile stress due to the shrinkage of solder when the electronic component is electrically connected to the mounting substrate b by using solder h. A specific aspect of “spaced” is described in an example described below.

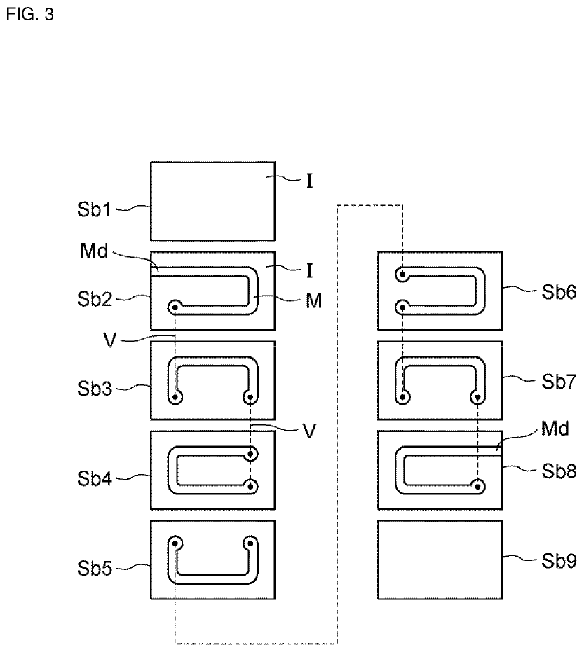

An example of the electronic component of the present disclosure is specifically described below by illustrating such a coil component as illustrated in FIGS. 2 and 3. The electronic component of the present disclosure is not limited to the coil component and may be a multilayer electronic component such as a capacitor, a varistor, an actuator, a thermistor, or a multilayer composite component or an electronic component other than the multilayer electronic component.

A coil component 1 of the present disclosure may include, for example, a body S in which a plurality of lamination members sb1 to sb9 are laminated, the first electrode e1, and the second electrode e2, the first electrode e1 and the second electrode e2 acting as outer electrodes. In an illustrated example, the nine lamination members sb1 to sb9 are laminated (refer to FIG. 3). The number of laminations is not limited to this example.

The outermost lamination members sb1 and sb9 are those that cover a coil conductor layer M described below and may each include an insulation layer I. The insulation layer I may be preferably composed of a magnetic material and more preferably composed of sintered ferrite. The insulation layer I may contain at least Fe, Zn, Cu, and Ni as major components. For example, Fe may be from 40.0 mol % to 49.5 mol % inclusive in terms of Fe₂O₃, Zn may be from 2 mol % to 35 mol % inclusive in terms of ZnO, Cu may be from 6 mol % to 13 mol % inclusive in terms of CuO, and Ni may be from 10 mol % to 45 mol % inclusive in terms of NiO. The insulation layer I may further contain an additive such as Co, Bi, Sn, or Mn or an impurity that is inevitable in manufacturing.

The lamination members sb2 to sb8 are disposed inside the outermost lamination members sb1 and sb9 and may include the above-mentioned insulation layer I, the coil conductor layer M, and a via conductor V.

The material that makes up the coil conductor layer M is not particularly limited. Examples of the material include Au, Ag, Cu, Pd, Ni, and/or the like. The material may be preferably Ag or Cu and more preferably Ag. An electrically conductive material may be used alone or two or more electrically conductive materials may be used in combination. The coil conductor layer M is configured in a shape in which end portions are not connected to each other like a U-shape (that is, a shape in which a coil conductor layer is not closed). The coil conductor layer M may be formed on the insulation layer I. The thickness of the coil conductor layer M is determined in accordance with a rated current that flows in the coil component. Increasing the thickness of the coil conductor layer M enables the resistance of the coil component to be reduced.

The coil conductor layers M of the lamination members sb2 and sb8 which adjoin the outermost lamination members sb1 and sb9, respectively, may be each provided with an extended portion Md (refer to FIG. 3) that acts as an extended wiring line electrically connected to the outer electrode E (the second electrode e2). Electric power is supplied to the coil conductor layer M by using the extended portion Md.

The via conductor V preferably contains the same material as the coil conductor layer M from a viewpoint of manufacturing and may contain a material different from that of the coil conductor layer M. The coil conductor layers M of the lamination members sb2 to sb8 may be electrically connected with the via conductors V interposed therebetween. The lamination members sb2 to sb8 of the present disclosure may be connected in series and desired coil characteristics can be obtained depending on the number of laminations.

In the body S formed by laminating the lamination members sb1 and sb9, a corner portion of the body S that is formed by the exposure surface S2 and the mounting surface S1 may be R-chamfered, but this is not an essential configuration. In a case where the corner portion is R-chamfered, when the outer electrode described below is formed, a region in which no electrode (first electrode or second electrode) is formed can be appropriately formed on the corner portion of the body S. A reason for this is described in detail in a method for manufacturing the electronic component.

The first electrode e1, which acts as the outer electrode, is attached to the mounting surface S1 of the body S that faces the mounting substrate b. The first electrode e1 preferably contains Ag or Cu. The outer electrode can be readily formed by dipping the body S in, for example, a Ag paste or a Cu paste. A method for forming the outer electrode of the electronic component of the present disclosure is not limited to the above-mentioned method in which the paste is used. For example, an electrode forming method such as a sputtering method or a vapor deposition method may be used. The thickness of the first electrode e1 is preferably from about 5 μm to about 20 μm inclusive.

The second electrode e2, which acts as the outer electrode, is attached to the exposure surface S2 of the body S from which the extended wiring line is exposed. The second electrode e2 may be composed of the same metal material as that of the first electrode e1 or may be composed a metal material different from that of the first electrode e1. The thickness of the second electrode e2 is greater than the thickness of the first electrode e1 and is preferably from 10 μm to 30 μm inclusive. Since the thickness of the second electrode e2 is greater than the thickness of the first electrode e1 as described above, the second electrode e2 can be electrically connected to the extended wiring line well.

The first electrode e1 and the second electrode e2 are formed so as to be spaced from each other. Thus, the electronic component electrically connected to the mounting substrate b by using solder h enables a reduction in the tensile stress due to the shrinkage of the solder h.

A third electrode e3 that covers the first electrode e1 and the second electrode e2 may be further included as an optional configuration in the outer electrode. The third electrode e3 may be, for example, a plated electrode for which the first electrode e1 and the second electrode e2 are base electrodes and may specifically include a Ni layer e3a and a Sn layer e3b. Ni may be used from a viewpoint of preventing solder corrosion and Sn may be used from a viewpoint of adhesion to solder.

Additive Configuration of Electronic Component of Present Disclosure

Furthermore, an insulation member c may be disposed between the first electrode e1 and the second electrode e2 as a preferable aspect of the electronic component of the present disclosure. According to this configuration, the first electrode e1 and the second electrode e2 can be appropriately spaced with the insulation member c.

The insulation member c may extend from the exposure surface S2 of the body S to the mounting surface S1 of the body S as a preferable aspect of the insulation member. This allows the spacing distance between the first electrode e1 and the second electrode e2 to be increased and enables the contact between the first electrode e1 and the second electrode e2 to be reduced.

The insulation member c may contain a glass material as a preferable aspect of the insulation member. Using this material enables the contact between the first electrode e1 and the second electrode e2 to be reduced because adhesion to the body S, which includes the insulation layer I, is favorable.

The thickness of the insulation member c may be from 0.5 μm to 3 μm inclusive as a preferable thickness of the insulation member. That is, the thickness of the insulation member c may be less than that of the first electrode e1 and the second electrode e2. From the relationship between the thickness of the insulation member c and the thickness of the first electrode e1 and the second electrode e2, it can be understood that the volume of the insulation member c is less than the sum of the volumes of the first electrode e1 and the second electrode e2.

Method for Manufacturing Electronic Component of Present Disclosure

Next, a method for manufacturing the electronic component of the present disclosure is described. A method for manufacturing a coil component is described as an example. The electronic component of the present disclosure is not limited to the coil component and may be a multilayer electronic component such as a capacitor, a varistor, an actuator, a thermistor, or a multilayer composite component or an electronic component other than the multilayer electronic component. The method for manufacturing the coil component includes a body preparing step and an outer electrode forming step.

Body Preparing Step

First, as raw materials, Fe₂O₃, ZnO, CuO, and NiO are weighed so as to give the above-mentioned predetermined composition. The raw materials are put into a ball mill together with pure water and partially stabilized zirconia (PSZ) balls, followed by mixing and crushing for four hours to eight hours by a wet method. After water is evaporated and drying is performed, calcination is performed at a temperature of 700° C. to 800° C. inclusive for two hours to five hours inclusive so as to prepare a calcine (calcined powder).

The prepared calcine is put into a ball mill together with PSZ media and a polyvinylbutyral-based organic binder, an organic solvent such as ethanol or toluene, and a plasticizer are further put into the ball mill and are mixed together. The mixture is formed into a sheet with a film thickness of 20 μm to 30 μm inclusive by a doctor blade method or the like and the sheet is punched into a rectangular shape so as to prepare the insulation layer I which is in a sheet shape (refer to, for example, FIG. 3).

A through-hole is formed by a laser at a predetermined spot on the prepared sheet-shaped insulation layer I. An electrically conductive material that is supplied to the through-hole is prepared. The electrically conductive material is, for example, a Ag powder or a Cu powder and is more preferably the Ag powder. A predetermined amount of a powder of the electrically conductive material is weighed and is kneaded with predetermined amounts of a solvent (eugenol or the like), a resin (ethyl cellulose or the like) and a dispersant in a planetary mixer or the like, followed by dispersion using a three-roll mill or the like, thereby enabling an electrically conductive paste to be prepared.

The electrically conductive paste is applied to the insulation layer I so as to form a predetermined shape of the coil conductor layer M and is supplied to the formed through-hole. A method for forming the electrically conductive paste is not limited to paste application and may be coating formation or the like.

The lamination members sb1 to sb9 prepared by the above procedure are stacked in a predetermined order (refer to, for example, FIG. 3) and are thermally pressure-bonded so as to prepare a multilayer body block. The multilayer body block is diced, followed by firing in a firing furnace at a temperature of 900° C. to 920° C. inclusive for two hours to four hours inclusive. Thereafter, as an optional step, a fired multilayer body is put into a rotary barrel machine and a corner portion is R-chamfered. The body S is prepared as described above.

Outer Electrode Forming Step

First, a Ag paste containing a Ag powder, a glass material, a resin, and a solvent as raw materials is prepared. The volume of the glass material is preferably less than the volume of the Ag powder. More preferably, the ratio of the volume of the glass material to the volume of the Ag powder is from 0.7 to 0.75 inclusive. The expression “the ratio of the volume of the glass material to the volume of the Ag powder” as used herein means a value calculated by dividing the volume of the glass material by the volume of the Ag powder. Adjusting the ratio of the volume of the glass material to the volume of the Ag powder in the range of 0.7 to 0.75 inclusive enables the spacing distance to be adjusted. As the volume ratio is closer to 0.7, the amount of the glass material is smaller and the spacing distance is smaller. As the volume ratio is closer to 0.75, the amount of the glass material is larger and the spacing distance is larger.

Dipping the body S in the prepared Ag paste allows the Ag paste to be thinly applied to the corner portion of the body S and to be thickly applied to the exposure surface S2 and mounting surface S1 of the body S.

After the body S is dipped in the Ag paste, a heat treatment is performed at a temperature of 750° C. to 850° C. inclusive for one minute to ten minutes inclusive. The heat treatment allows Ag on the corner portion of the body S to flow on the upper surface, lower surface, or exposure surface S2 of the body S so as to form the first electrode e1 and the second electrode e2. On the other hand, the glass material remains on the corner portion to form the insulation member c. R-chamfering the corner portion of the body S enables Ag in the paste to flow preferably on the upper surface, lower surface, or exposure surface S2 of the body S along an R-surface. The forming method allows the thickness of the second electrode e2 to be greater than the thickness of the first electrode e1. Since the second electrode e2 is thickly formed, the extended wiring line can be electrically connected thereto appropriately.

As described above, the first electrode e1; the second electrode e2, which is spaced from the first electrode e1; and the insulation member c can be formed on the body S. In the above-mentioned formation of the first electrode e1 and second electrode e2, a forming method to dip in the Ag paste has been described. The formation thereof is not limited to this example. For example, an electrode forming method such as a sputtering method or a vapor deposition method may be used. In the formation of the insulation member c, a forming method to dip in paste containing the glass material has been described. The formation thereof is not limited to this example. Before or after the first electrode e1 and the second electrode e2 are formed, the insulation member c may be formed by a forming method other than dipping (for example, sputtering, a CVD method, or the like).

After the first electrode e1 and the second electrode e2 are formed, the third electrode e3, which is a plated electrode for which the first electrode e1 and the second electrode e2 are base electrodes, may be formed. The third electrode e3 may include the Ni layer e3a and the Sn layer e3b. Ni may be used from a viewpoint of preventing solder corrosion and Sn may be used from a viewpoint of adhesion to solder.

As described above, the coil component can be manufactured as an example of the electronic component of the present disclosure.

### Examples

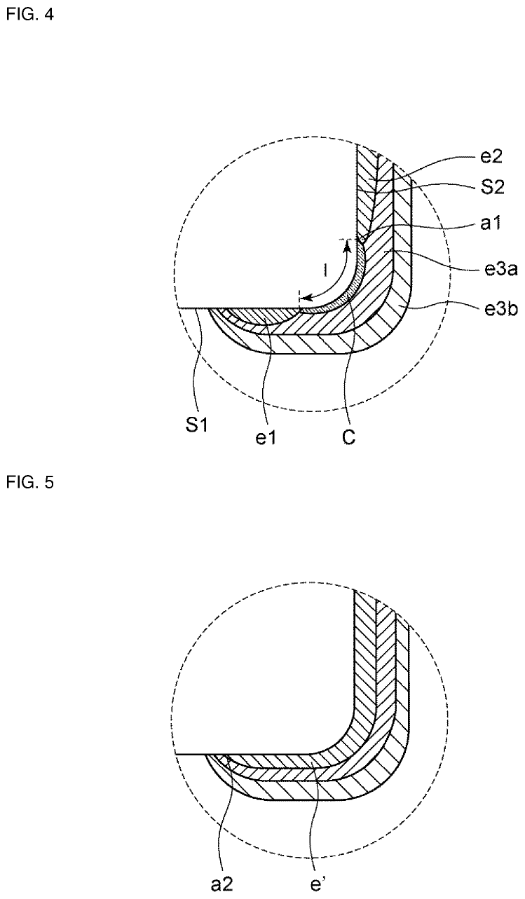

A verification simulation was performed on an “electronic component” according to the present disclosure. Specifically, as illustrated in FIG. 4, in an electronic component including a first electrode e1 and a second electrode e2 spaced from each other, the stress applied to a mounting surface-side end portion a1 of the second electrode e2 attached to an exposure surface S2 was calculated. Stress was calculated for seven types of samples in which the spacing distance between the first electrode e1 and the second electrode e2 was 6 μm, 18 μm, 30 μm, 36 μm, 42 μm, 54 μm, or 66 μm. Incidentally, the spacing distance means the length between the first electrode e1 and the second electrode e2 along an outer surface of a body S. In FIG. 4, the spacing distance is length 1.

As a comparative example, in an electronic component including an electrode e′ formed along an outer surface of a body as illustrated in FIG. 5, the stress applied to an end portion a2 of the electrode e′ was calculated.

Femet (R) developed by Murata Software Co., Ltd. was used for stress calculation. Results of stress calculation are shown in the table below. The rate of reduction (%) in the table is the calculated stress of an example with respect to the calculated stress of the electronic component of the comparative example [100%−{(calculated stress)/(calculated stress of comparative example)}%].

TABLE 1

| Spacing distance | Rate of reduction |
|---|---|
| Comparative example (Fig. 5) | 0% |
| Example (Fig. 4): 6 μm | 50% |
| Example (Fig. 4): 18 μm | 60% |
| Example (Fig. 4): 30 μm | 55% |
| Example (Fig. 4): 36 μm | 95% |
| Example (Fig. 4): 42 μm | 95% |
| Example (Fig. 4): 54 μm | 90% |
| Example (Fig. 4): 66 μm | 95% |

According to Table 1, the following result was obtained: the calculated stress in the electronic components including the first electrode e1 and the second electrode e2 spaced from each other was reduced compared with the comparative example (FIG. 5). In particular, when the length between the first electrode e1 and the second electrode e2 along the outer surface of the body S was from 6 μm to 66 μm inclusive, the rate of reduction in calculated stress was 50% or more and a stress reduction effect was obtained. Furthermore, when the length between the first electrode e1 and the second electrode e2 along the outer surface of the body S was from 36 μm to 66 μm inclusive, the rate of reduction in calculated stress was 90% or more and a further stress reduction effect was obtained.

In the above-mentioned stress reduction effect of the examples, a verification simulation performed on a coil component including an insulation member c revealed that a coil component including no insulation member exhibited substantially the same rate of reduction. That is, the insulation member c may be an optional configuration.

An electronic component was actually prepared using a Ag powder (70 wt %) and a glass material (12 wt %) as materials of an outer electrode (in this case, the ratio of the volume of the glass material to the volume of the Ag powder was about 0.72). In the case of this volume ratio, the length between the first electrode e1 and the second electrode e2 along the outer surface of the body S was 36 μm.

An electronic component in which the length between the first electrode e1 and the second electrode e2 along the outer surface of the body S was long could be manufactured in a manner in which the ratio of the volume of a glass material to the volume of a Ag powder to be adjusted close to 0.75 in the range of 0.7 to 0.75 inclusive.

The embodiments disclosed herein are illustrative in all respects and do not serve as a basis for limitative interpretation. Thus, the technical scope of the present disclosure should not be interpreted in accordance with only the forgoing embodiments but should be defined on the basis of what is described in the claims. In addition, the technical scope of the present disclosure includes all modifications within the meaning and scope equivalent to the claims.

An electronic component of the present disclosure has been described using an inductor as an example. The electronic component is not limited to the inductor and can be widely used as a multilayer electronic component such as a capacitor, a varistor, an actuator, a thermistor, or a multilayer composite component, an electronic component other than the multilayer electronic component, or the like in various applications.

What is claimed is:

1. An electronic component comprising:
a body having a mounting surface which faces a mounting substrate and an exposure surface from which an extended wiring line is exposed;
a first electrode attached to the mounting surface; and
a second electrode which is electrically connected to the extended wiring line and which is attached to the exposure surface,
wherein the first electrode and the second electrode are spaced from each other.

2. The electronic component according to claim 1, wherein
the body has a corner portion that is configured by the exposure surface and the mounting surface and that is R-chamfered.

3. The electronic component according to claim 1, further comprising:
a third electrode that covers the first electrode and the second electrode.

4. The electronic component according to claim 3, wherein
the third electrode is a plated electrode that contains Ni and Sn.

5. The electronic component according to claim 1, wherein
the first electrode or the second electrode contains Ag or Cu.

6. The electronic component according to claim 1, wherein
the body has a length between the first electrode and the second electrode along an outer surface of the body, the length being from 6 μm to 66 μm inclusive.

7. The electronic component according to claim 1, wherein
an insulation member is disposed between the first electrode and the second electrode.

8. The electronic component according to claim 7, wherein
the insulation member extends from the exposure surface to the mounting surface.

9. The electronic component according to claim 7, wherein
the insulation member contains a glass material.

10. A coil component comprising:
the electronic component according to claim 1, in which the body includes coil conductor layers, via conductors and insulation layers, that are laminated together.

11. The electronic component according to claim 2, further comprising:
a third electrode that covers the first electrode and the second electrode.

12. The electronic component according to claim 2, wherein
the first electrode or the second electrode contains Ag or Cu.

13. The electronic component according to claim 3, wherein
the first electrode or the second electrode contains Ag or Cu.

14. The electronic component according to claim 4, wherein
the first electrode or the second electrode contains Ag or Cu.

15. The electronic component according to claim 2, wherein
the body has a length between the first electrode and the second electrode along an outer surface of the body, the length being from 6 μm to 66 μm inclusive.

16. The electronic component according to claim 3, wherein
the body has a length between the first electrode and the second electrode along an outer surface of the body, the length being from 6 μm to 66 μm inclusive.

17. The electronic component according to claim 2, wherein
an insulation member is disposed between the first electrode and the second electrode.

18. The electronic component according to claim 3, wherein
an insulation member is disposed between the first electrode and the second electrode.

19. The electronic component according to claim 8, wherein
the insulation member contains a glass material.

20. A coil component comprising:
the electronic component according to claim 2, in which the body includes coil conductor layers, via conductors and insulation layers, that are laminated together.
